(19) United States
(12) Patent Application Publication
(10) Pub. No.: US 2009/0322875 A1
(43) Pub. Date: Dec. 31, 2009

(54) SURVEILLANCE SYSTEM, SURVEILLANCE METHOD AND COMPUTER READABLE MEDIUM

(75) Inventor: Ichiro Toyoshima, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/108,702

(22) Filed: Apr. 24, 2008

(30) Foreign Application Priority Data
Apr. 27, 2007 (JP) 2007-118361

(51) Int. Cl. H04N 7/18

(52) U.S. Cl. 348/143; 348/E07.085

(57) ABSTRACT

There is provided with a surveillance system including: a receiving unit configured to receive images taken by surveillance cameras; a feature vector calculator configured to calculate feature vectors each including one or more features from received images; a database configured to store a plurality of learning data each including the feature vector and one of a plurality of classes; an classification processing unit configured to perform class identification of each of calculated feature vectors by using a part or all of the learning data plural times to obtain plural classes for each of the calculated feature vectors, respectively; a selecting unit configured to select a predetermined number of surveillance cameras based on dispersion of obtained classes for each of the calculated feature vectors corresponding to the surveillance cameras; and an image output unit configured to output images taken by selected surveillance cameras to monitor display devices respectively.

### CROSS REFERENCE TO RELATED APPLICATIONS

This application is based upon and claims the benefit of priority from the prior Japanese Patent Applications No. 2007-118361, filed on Apr. 27, 2007; the entire contents of which are incorporated herein by reference.

### BACKGROUND OF THE INVENTION

1. Field of the Invention

The present invention relates to a surveillance system, a surveillance method and a computer readable medium.

2. Related Art

A surveillance system in the large facilities is inevitably required to have many cameras, however the increasing number of cameras leads to the increasing number of videos to be monitored.

Though there is substantially no upper limit on the number of surveillance cameras, the number of monitors that can be visually recognized at any time by one manager is physically and spatially limited, whereby it is impossible to supervise the images from all the cameras at the same time.

To solve this problem, an automatic detection method for automatically detecting a problem state through image processing has been studied, but it is inevitable that there is a detection error or a misdetection due to essential limitations of the statistical pattern recognition.

An image in a vague situation requiring the person's judgment should be directly judged by the person, whereby a method for automatically specifying such image is needed.

### BRIEF DESCRIPTION OF THE DRAWINGS

FIG. 1 is a block diagram showing the overall configuration of a surveillance system according to one embodiment of the present invention;

FIG. 2 is a view showing an example of a database with supervised values for classification;

FIG. 3 is a view for explaining the processing of an max data number computing unit;

FIG. 4 is a view showing an example of N−k+1 classification results; and

FIG. 5 is a view for explaining the processing of an output image deciding unit.

### SUMMARY OF THE INVENTION

According to an aspect of the present invention, there is provided with a surveillance system comprising:

a receiving unit configured to receive images taken by a plurality of surveillance cameras;

a feature vector calculator configured to calculate feature vectors each including one or more features from received images;

a database configured to store a plurality of learning data each including the feature vector and one of a plurality of classes;

an classification processing unit configured to perform class identification of each of calculated feature vectors by using a part or all of the learning data plural times to obtain plural classes for each of the calculated feature vectors,

respectively;

a selecting unit configured to select a predetermined number of surveillance cameras based on dispersion of obtained classes for each of the calculated feature vectors corresponding to the surveillance cameras; and

an image output unit configured to output images taken by selected surveillance cameras to monitor display devices respectively.

According to an aspect of the present invention, there is provided with a surveillance method comprising:

receiving images taken by a plurality of surveillance cameras;

calculating feature vectors each including one or more features from received images;

accessing a database configured to store a plurality of learning data each including the feature vector and one of a plurality of classes;

performing class identification of each of calculated feature vectors by using a part or all of the learning data plural times to obtain plural classes for each of the calculated feature vectors, respectively;

selecting a predetermined number of surveillance cameras based on dispersion of obtained classes for each of the calculated feature vectors corresponding to the surveillance cameras; and

outputting images taken by selected surveillance cameras to monitor display devices respectively.

According to an aspect of the present invention, there is provided with a computer readable medium storing a computer program for causing a computer to execute instructions to perform the steps of:

receiving images taken by a plurality of surveillance cameras;

calculating feature vectors each including one or more features from received images;

accessing a database configured to store a plurality of learning data each including the feature vector and one of a plurality of classes;

performing class identification of each of calculated feature vectors by using a part or all of the learning data plural times to obtain plural classes for each of the calculated feature vectors, respectively;

selecting a predetermined number of surveillance cameras based on dispersion of obtained classes for each of the calculated feature vectors corresponding to the surveillance cameras; and

outputting images taken by selected surveillance cameras to monitor display devices respectively.

### DETAILED DESCRIPTION OF THE INVENTION

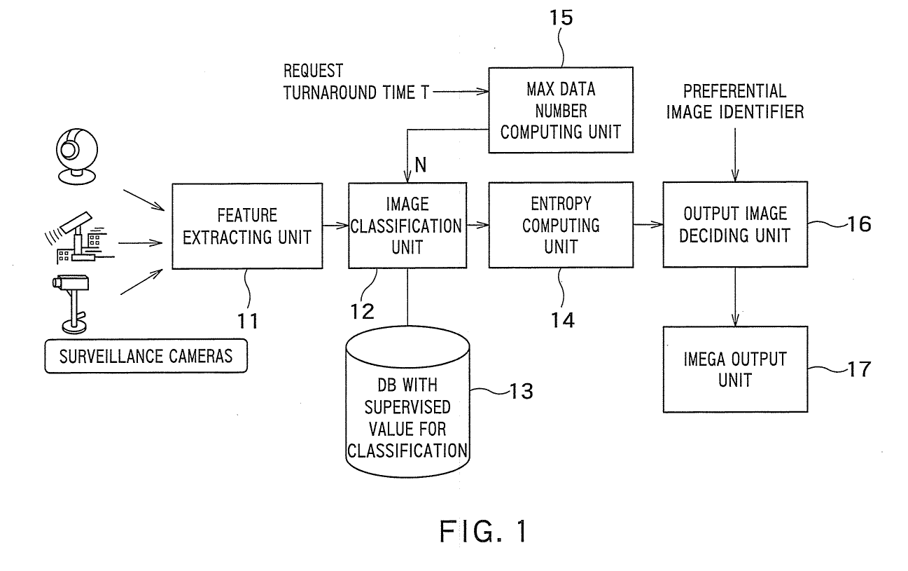

FIG. 1 is a block diagram showing the overall configuration of a surveillance system according to one embodiment of the present invention.

A motion picture for a certain period of time inputted from each surveillance camera is inputted into a feature amount extracting unit (feature vector calculator) 11. The feature amount extracting unit includes a receiving unit which receives images taken by the surveillance cameras. The feature amount extracting unit 11 extracts one or more features representing the feature of image from each image (motion picture). The extracted one or more features are outputted as the finite dimensional vector data (feature vector) to an image classification unit 12.

The extracted feature amount may be the value directly calculated from the image such as background subtraction, optical flow, or high order local auto-correlation feature amount, or the count value indicating the behavior of a monitoring object on the screen such as a residence time or range of motion of the person on the screen.

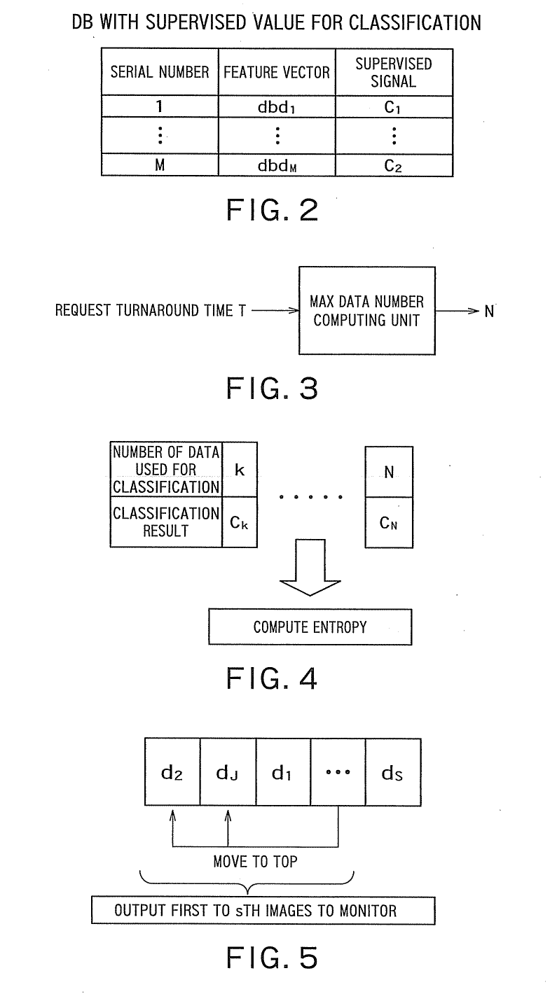

A database (DB: DataBase) with supervised values for classification 13 prestores the feature vectors each assigned a supervised signal. FIG. 2 is a view showing one example of the database 13. The database 13 stores plural sets of learning data (instances). Each set includes the serial number, the feature vector and the supervised signal. The supervised signal is binary data having one of values (classes) “normal” (=C₁) and “abnormal” (=C₂) for making normality/abnormality determination for a surveillance camera image. Each learning data has a preset order of priority.

An image classification unit (classification processing unit) 12 performs identifying processing for each feature vector inputted from the feature extracting unit 11 plural times, respectively, using the DB 13 and thereby produces plural classification results (i.e., plural values indicating “normal” or “abnormal”) for each feature vector, respectively. That is, plural classification results are obtained for each feature vector, respectively. As a classification algorithm, a k-Nearest Neighbor (hereinafter abbreviated as k-NN. “k” is a hyper parameter of k-NN) method can be used and suppose the k-Nearest Neighbor is used in this example. The number of making the classification is indicated by N−k+1, wherein “N” indicates the maximum number of learning data used for classification.

The image classification unit 12 will be described below in more detail.

As described above, the image classification unit 12 operates for each input feature vector. If “L” (=number of surveillance cameras) input images exist, “L” sets of classification results are obtained. In the following, the operation of the image classification unit 12 for one feature vector will be described for simplicity of explanation.

The k-NN method for use in the image classification unit 12 is a classical classification method, and well known to provide high classification ability if the data structure is complex and an abundant amount of learning data is available.

A method for classification using the general k-NN method includes computing the distance between input data and all the learning data and selecting the upper “k” pieces of learning data nearer to the input data. And an imputed class of the input data is identified based on majority rule.

The k-NN method is described in detail in the following document and the like.

T. Hastie, R. Tibshirani, J. H. Friedman “The Elements of Statistical Learning”, Springer 2001 ISBN-10: 0387952845.

Though the general k-NN method computes the distance from all the learning data as described above, if the “k” or more classification are ended (the distance from “k” or more pieces of learning data is computed) even during computation, classification can be made by selecting the upper “k” pieces of data from the “k” or more pieces of identified learning data.

In this embodiment, if the maximum number “N” of learning data used for classification is greater than “k”, classification is made by increasing the learning data one by one from “k” pieces of learning data to “N” pieces of learning data, whereby N−k+1 classification are made. The learning data is preferentially selected in descending order of priority each time (accordingly, the learning data with higher order of priority is used in duplicate each time). In this way, N−k+1 classification results are obtained by making the classification N−k+1 times. An example of N-k+1 classification results is shown in FIG. 4.

The maximum number “N” of learning data used for classification is computed by the max data number computing unit 15. The max data number computing unit 15 computes the maximum number “N” of data used for classification from the request turnaround time “T” and the system performance as shown in FIG. 3.

A decrease in the performance of k-NN without using all the learning data can be prevented by using a structured method for learning data as proposed in the following document [Ueno06]. The order of priority for each learning data within the database 13 may be set based on the method of [Ueno06].

[Ueno06] Ken Ueno. et. al. Towards the Anytime Stream Classification with Index Ordering Heuristics Using the Nearest Neighbor Algorithm. IEEE Int. Conf. Data Mining06

Even when the distance is not computed for all the learning data with an ordering method as proposed in the document [Ueno06] or heuristics specific to the object, the sufficient precision can be secured, if “N” is large enough. For example, if “N” is large enough, the sufficient precision can be secured, even though the order of priority for each learning data in the database 13 is set randomly.

Turning back to FIG. 1, the entropy computing unit (classification processing unit) 14 computes the entropy of each feature vector, using the N−k+1 classification results for each feature vector (see FIG. 4). If “L” input images exist, “L” entropies are computed. The entropy is one example of dispersion information indicating dispersion of plural classification results (classes).

The computation of entropy can be performed using the following generally used expression.

Entropy E=−Σqᵢ log₂ qᵢ

Here “qᵢ” is the probability of event “i”, and the ratio of each class in the entire plural classification results in this example. A method for computing the entropy may be performed using not only the general definitional expression, but also a ratio difference between classes, or a count difference between classes.

The output image deciding unit (selecting unit) 16 orders (arranges) the feature vectors in descending order of entropy computed by the entropy computing unit 14. From the definition of entropy, the feature vector with large entropy is dispersed in the classification results thereof, whereby there is high possibility that such feature vector is located near the interface between classes. Therefore, preferentially displaying the image of the feature vector with large entropy is equivalent to displaying the image “to be recognized by a person” that is difficult to automatically recognize with the computer. A variety of ordering algorithms are well known, and any other algorithm can be used.

After the end of ordering, some feature vectors are moved to the top, based on the following two stage rules.

(1) At first, the feature vector corresponding to the surveillance camera identifier (preferential image identifier) designated by the output image deciding unit 16 from the outside (user) is moved to the top. That is, the surveillance camera designated from the outside is preferentially selected over the surveillance camera determined from the order of entropy. The output image deciding unit 16 includes a designation accepting unit. FIG. 5 shows this process. dx(x=1, . . . , S, . . . , L) (“L” being the number of surveillance cameras, “S” being the number of monitor display devices) denotes the feature vector calculated by the feature extracting unit 11. This stage is made to continuously display the facility entrance or the like where the monitoring is required at any time on the monitor display device.

(2) Next, a predetermined number of feature vectors with more classification results (classes) of “abnormal” (greater than or equal to a threshold) are taken out in order from the end of the ordered feature vectors and moved to the top. That is, the surveillance camera corresponding to the feature vector for which the number in a specific class is greater is preferentially selected over the surveillance camera designated from the outside and moreover the surveillance camera determined from the order of entropy. This is because the feature vector has high urgency if the entropy is low but the possibility of abnormal state is high.

After performing the movement processes (1) and (2), “s” (the number of monitor display devices for image output) upper level feature vectors are selected, and the surveillance camera identifiers corresponding to the selected feature vectors are sent to the image output unit 17.

The image output unit 17 displays the image of the surveillance camera (the current image of the surveillance camera photographing the place where there has been something unusual immediately before) corresponding to each received surveillance camera identifier on the corresponding monitor display devices.

As described above, according to this embodiment, for the image obtained from the surveillance camera, the degree of ambiguity of classification results is computed from the dispersion of the classification results (classes) obtained by making the classification plural times using an improved algorithm of the k-Nearest Neighbor method, and the image of the surveillance camera with high degree of ambiguity is preferentially displayed, whereby it is possible to automatically specify and display the image in a vague situation requiring the person's judgment, and make the confirmation operation more efficient.

Incidentally, this surveillance system may also be implemented by using, for example, a general-purpose computer device as basic hardware. That is, the feature extracting unit 11, the image classification unit 12, the entropy computing unit 14, the max data number computing unit 15, the output image deciding unit 16 and the image output unit 17 can be implemented by causing a processor mounted in the above described computer device to execute a program. In this case, the surveillance system may also be implemented by pre-installing the above described program in a computer device or by storing the program in a storage medium such as CD-ROM or distributing the above described program via a network and installing this program in a computer device as appropriate. Furthermore, the dictionary memories may be implemented by using a memory, hard disk incorporated in or externally attached to the above described computer device or a storage medium such as CD-R, CD-RW, DVD-RAM and DVD-R as appropriate.

What is claimed is:

1. A surveillance system comprising:
a receiving unit configured to receive images taken by a plurality of surveillance cameras;
a feature vector calculator configured to calculate feature vectors each including one or more features from received images;
a database configured to store a plurality of learning data each including the feature vector and one of a plurality of classes;
an classification processing unit configured to perform class identification of each of calculated feature vectors by using a part or all of the learning data plural times to obtain plural classes for each of the calculated feature vectors, respectively;
a selecting unit configured to select a predetermined number of surveillance cameras based on dispersion of obtained classes for each of the calculated feature vectors corresponding to the surveillance cameras; and
an image output unit configured to output images taken by selected surveillance cameras to monitor display devices respectively.

2. The system according to claim 1, wherein an order of priority is set to each learning data of the database, and the classification processing unit selects a different number of learning data in the order of descending priorities in the class identification at each time.

3. The system according to claim 1, wherein the selecting unit preferentially selects the surveillance camera corresponding to the feature vector with a greater dispersion of the obtained classes.

4. The system according to claim 1, wherein the dispersion is entropy.

5. The system according to claim 3, further comprising a designation accepting unit configured to accept a designation of one or more surveillance camera,
wherein the selecting unit preferentially selects a designated surveillance camera and then selects the surveillance cameras based on the dispersion.

6. The system according to claim 5, wherein the selecting unit preferentially selects the surveillance camera corresponding to the calculated feature vector for which a specific class is obtained more than a threshold number over the surveillance camera designated by the designation accepting unit.

7. The system according to claim 3, wherein the selecting unit preferentially selects the surveillance camera corresponding to the calculated feature vector for which a specific class is obtained more than a threshold number and then selects the surveillance camera based on the dispersion.

8. A surveillance method comprising:
receiving images taken by a plurality of surveillance cameras;
calculating feature vectors each including one or more features from received images;
accessing a database configured to store a plurality of learning data each including the feature vector and one of a plurality of classes;
performing class identification of each of calculated feature vectors by using a part or all of the learning data plural times to obtain plural classes for each of the calculated feature vectors, respectively;
selecting a predetermined number of surveillance cameras based on dispersion of obtained classes for each of the calculated feature vectors corresponding to the surveillance cameras; and
outputting images taken by selected surveillance cameras to monitor display devices respectively.

9. The method according to claim 8, wherein an order of priority is set to each learning data of the database, and the performing class identification selects a different number of learning data in the order of descending priorities in the class identification at each time.

10. The method according to claim 8, wherein the selecting a predetermined number of surveillance cameras preferentially selects the surveillance camera corresponding to the feature vector with a greater dispersion of the obtained classes.

11. The method according to claim 8, wherein the dispersion is entropy.

12. The method according to claim 10, further comprising accepting a designation of one or more surveillance camera,
wherein the selecting a predetermined number of surveillance cameras preferentially selects a designated surveillance camera and then selects the surveillance cameras based on the dispersion.

13. The method according to claim 12, wherein the selecting a predetermined number of surveillance cameras preferentially selects the surveillance camera corresponding to the calculated feature vector for which a specific class is obtained more than a threshold number over the surveillance camera designated.

14. The method according to claim 10, wherein the selecting a predetermined number of surveillance cameras preferentially selects the surveillance camera corresponding to the calculated feature vector for which a specific class is obtained more than a threshold number and then selects the surveillance camera based on the dispersion.

15. A computer readable medium storing a computer program for causing a computer to execute instructions to perform the steps of:
receiving images taken by a plurality of surveillance cameras;
calculating feature vectors each including one or more features from received images;
accessing a database configured to store a plurality of learning data each including the feature vector and one of a plurality of classes;
performing class identification of each of calculated feature vectors by using a part or all of the learning data plural times to obtain plural classes for each of the calculated feature vectors, respectively;
selecting a predetermined number of surveillance cameras based on dispersion of obtained classes for each of the calculated feature vectors corresponding to the surveillance cameras; and
outputting images taken by selected surveillance cameras to monitor display devices respectively.

16. The medium according to claim 15, wherein an order of priority is set to each learning data of the database, and the performing class identification selects a different number of learning data in the order of descending priorities in the class identification at each time.

17. The medium according to claim 15, wherein the selecting a predetermined number of surveillance cameras preferentially selects the surveillance camera corresponding to the feature vector with a greater dispersion of the obtained classes.

18. The medium according to claim 15, wherein the dispersion is entropy.

19. The medium according to claim 17, further comprising a program for causing the computer to execute instructions to perform to accept a designation of one or more surveillance camera,
wherein the selecting a predetermined number of surveillance cameras preferentially selects a designated surveillance camera and then selects the surveillance cameras based on the dispersion.

20. The medium according to claim 19, wherein the selecting a predetermined number of surveillance cameras preferentially selects the surveillance camera corresponding to the calculated feature vector for which a specific class is obtained more than a threshold number over the surveillance camera designated.

21. The medium according to claim 17, wherein the selecting a predetermined number of surveillance cameras preferentially selects the surveillance camera corresponding to the calculated feature vector for which a specific class is obtained more than a threshold number and then selects the surveillance camera based on the dispersion.
